(19) United States
(12) Patent Application Publication
(10) Pub. No.: US 2003/0089855 A1
(43) Pub. Date: May 15, 2003

(54) Detection of ions in a fluid medium

(75) Inventors: Steven H. Strauss, Fort Collins, CO (US); Matthew A. Odom, Longmont, CO (US); Brady Clapsaddle, Fort Collins, CO (US); Gretchen N. Hebert, Fort Collins, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Colorado State University Research Foundation, Fort Collins, CO (US)

(21) Appl. No.: 09/938,263

(22) Filed: Aug. 23, 2001

Related U.S. Application Data
(60) Provisional application No. 60/227,758, filed on Aug. 24, 2000.

(51) Int. Cl. G01J 5/02

(52) U.S. Cl. 250/339.07

(57) ABSTRACT

The present invention provides a method and apparatus for detecting a presence of an analyte in a fluid medium. Specifically, the present invention provides a detection probe comprising an analyte affinity compound which has a higher affinity for the analyte in a fluid medium than the fluid medium itself. In this manner, the analyte in the fluid medium is concentrated onto the detection probe. The present invention also provides a method for using the same in qualitative or quantitative analysis of the analyte in a fluid medium.

### CROSS REFERENCE TO RELATED APPLICATIONS

This application claims the benefit of U.S. Provisional Application No. 60/227,758, filed Aug. 24, 2000, which is incorporated herein by reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No. AMSRL-RO-RI 41567-CH awarded by U.S. Army Research Office and Grant No. CTS-0085892 awarded by National Science Foundation.

### FIELD OF THE INVENTION

The present invention is directed to a method and apparatus for detecting a presence of an analyte in a fluid medium.

### BACKGROUND OF THE INVENTION

The ability to detect a presence of, or to quantify the amount of, a pollutant in a solution is generally limited by the concentration of the pollutant and the sensitivity of the method utilized.

One of the useful tools for determining the presence of trace contaminants in a variety of samples is infrared (i.e., IR) spectroscopy. However, the usefulness of IR spectroscopy for water samples has been limited due to water's strong absorbance of electromagnetic radiation in the infrared region. This problem can be mitigated by using waveguide sampling (i.e., attenuated total reflection or ATR) IR spectroscopy, which allows aqueous samples to be monitored via IR spectroscopy. Unfortunately, the detection limits for current ATR IR spectroscopy are inadequate for determining trace amounts of contaminants. Typically, detection limits are constrained due to absorption of IR radiation by water and the small volume of solution probed by the evanescent wave that propagates out of the waveguide (i.e., the ATR crystal) into the solution.

A number of methods have been developed to decrease the detection limit (i.e., increasing the sensitivity) in ATR sampling for organic compounds, such as pesticides and insecticides. Such methods include coating the waveguide surface with a thin film which is designed to interact with organic compounds (e.g., typically by hydrophobic interactions). It is believed that this interaction between the thin film and an organic compound increases the net concentration of the organic compound in the region sampled by the evanescent wave, thereby effectively reducing the detection limit of ATR IR spectroscopy.

Unfortunately, these films are not applicable to detecting analytes such as ionic pollutants, including weakly-hydrated ions, in fluid mediums, e.g., aqueous solutions. In addition, most conventional thin films currently used in ATR IR spectroscopy are not capable of being rapidly deactivated and reactivated for repeated use in detecting pollutants. Furthermore, such activation and deactivation result in loss of performance. Moreover, conventional thin films used in ATR IR spectroscopy require time consuming processes to reactivate the films after each use.

Therefore, there is a need for rapidly detecting analytes, such as ionic pollutants, in a solution. There is also a need for an analyte affinity compound which can be attached to a detection probe of an analytical device. There is also a need for an analyte affinity compound that can be rapidly deactivated and reactivated for detecting analytes.

### SUMMARY OF THE INVENTION

The present invention provides a detection probe which provides a higher concentration of an analyte on the detection probe relative to the concentration of the analyte in a fluid medium and a method for using the same.

The detection probe comprises a detection zone which is used to transmit a signal to the analytical device. The analytical device then transforms the signal that is generated by the detection zone and allows one to interpret the identity and/or the presence of the analyte. Typically, analytical devices have a detection limit for an analyte such that when the analyte is present at a concentration below a certain level, it is difficult to determine or detect the presence of a particular analyte.

The present invention provides an analyte affinity compound which can be attached to the detection probe, in particular to the detection zone of the probe, whereby the net effective concentration of the analyte proximal to the detection zone is increased relative to the actual concentration of the analyte in the fluid medium. In this manner, the detection limit of the analytical device can be reduced by the presence of the analyte affinity compound.

Unlike the conventional thin films that are used to reduce the detection limit of an analytical device, the analyte affinity compounds of the present invention can be activated and deactivated without a significant loss of performance. Preferably, the analyte affinity compounds of the present invention can be activated and deactivated for at least about 7 cycles without a significant loss of performance. More preferably, the analyte affinity compounds of the present invention can be activated and deactivated for at least about 20 cycles, and more preferably at least about 100 to 1,000 cycles, without a significant loss of performance. As used herein, the term “without a significant loss of performance” means the analyte affinity compound which is attached to the detection probe maintains at least about 95% of its initial activity, preferably at least about 98%, and more preferably at least about 99%. The term “activity” when referring to the performance of the analyte affinity compound refers to the amount of signal generated by the detection probe having the analyte affinity compound attached to its surface.

Preferably, the analyte affinity compound forms a thin film coating on a surface of the detection probe. The thin film can be temporarily or permanently attached to the detection probe. In addition, the thin film can also include a linker which is used to attach the analyte affinity compound to the detection probe. In one particular embodiment of the present invention, the analyte affinity compound is covalently bonded to a surface of the detection probe. Preferably, the analyte affinity compound is a redox-recyclable compound.

In one particular embodiment of the present invention, oxidation of the analyte affinity compound results in the analyte affinity compound which is cationic which requires the presence of an anionic counterion. When the ionizable analyte affinity compound is contacted with the fluid medium containing the target anion, anion ion exchange occurs leading to a higher local concentration of the target anion on the detection probe relative to the concentration of the target anion in the fluid medium. The analyte affinity compound can be activated and deactivated (e.g., oxidized and reduced, respectively) electrochemically or by using inexpensive redox agents. Deactivation of the analyte affinity compound results in a neutral form of the analyte affinity compound which releases the target anion from the analyte affinity coating on the detection probe.

In another embodiment, the active analyte affinity compound can be a neutral form and the deactivated analyte affinity can be an ionic (e.g., cationic) form. This particular embodiment is useful in increasing the local concentration of a neutral analyte (e.g., organic compound) relative to the concentration of the analyte in a fluid medium.

In one particular embodiment of the present invention, the analyte affinity compound is of the formula:

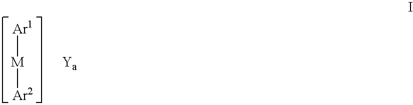

where each of Ar¹ and Ar² is independently optionally substituted C₄-C₂₀ aryl; preferably each of Ar¹ and Ar² is independently alkyl substituted cyclopentadienyl, or indenyl. M is a transition metal, preferably Fe, Co, Ni, Ru, Mg, Cr, Os, Rh or Ir. Y is an anion, preferably nitrate, chloride, fluoride, hydrosulfate, perchlorate, perrhenate, hexafluorophosphate, carboxylate (e.g., acetate), triflate, or perfluoroalkylsulfonate. And a is 0 when the analyte affinity compound is reduced, and a is an integer from 1 to 3, preferably 1, when the analyte affinity compound is oxidized.

In one particular embodiment of the present invention, the analyte affinity compound is selected from the group consisting of 1,1′,3,3′-tetrakis(2-methyl-2-hexyl)ferricenium nitrate (i.e., HEP⁺NO₃⁻), 1,1′,3,3′-tetrakis(2-methyl-2-hexyl)ferricenium chloride (i.e., HEP⁺Cl⁻), 1,1′,3,3′-tetrakis(2-methyl-2-nonyl)ferricenium nitrate (i.e., DEC⁺NO₃⁻), 1,1′,3,3′-tetrakis(2-methyl-2-nonyl)ferricenium chloride (i.e., DEC⁺Cl⁻), 1,1′,3,3′-tetrakis(2-methyl-2-nonyl)ferrocenium fluoride (i.e., DEC⁺F⁻), 1,1′,3,3′-tetrakis(2-methyl-2-nonyl)ferrocenium acetate (i.e., DEC⁺acetate⁻), 1,1′,3,3′-tetrakis(2-methyl-2-nonyl)ferrocenium hydrosulfate (i.e. DEC⁺HSO₄⁻), 1,1′,3,3′-tetrakis(2-methyl-2-nonyl)ferrocenium undeca-closo-monocarborane (i.e., DEC⁺CB₁₁H₁₂⁻), Ni(DPPP)Cl₂ and the Eu/styrene molecularly imprinted polymer (i.e., MIP). More preferably, the analyte affinity compound is selcted from the group consisting of 1,1′,3,3′-tetrakis(2-methyl-2-hexyl)ferrocenium nitrate, 1,1′,3,3′-tetrakis(2-methyl-2-hexyl)ferrocenium chloride, 1,1′,3,3′-tetrakis(2-methyl-2-nonyl)ferrocenium nitrate, 1,1′,3,3′-tetrakis(2-methyl-2-nonyl)ferrocenium chloride, 1,1′,3,3′-tetrakis(2-methyl-2-nonyl)ferrocenium fluoride, 1,1′,3,3′-tetrakis(2-methyl-2-nonyl)ferrocenium acetate, 1,1′,3,3′-tetrakis(2-methyl-2-nonyl)ferrocenium hydrosulfate and 1,1′,3,3′-tetrakis(2-methyl-2-nonyl)ferrocenium undeca-closo-monocarborane.

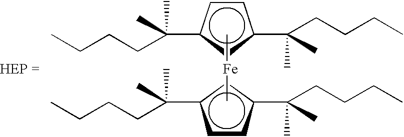

The detection probes of the present invention can be IR spectroscopy detection probes or electrochemical probes which measure electric conductivity, resistivity, capacity, or current as a function of potential. Preferably, IR spectroscopy detection probes are attenuated total reflection IR spectroscopy probes, i.e., ATR IR sensing elements.

The detection probes of the present invention are well suited for qualitative and/or quantitative analysis of weakly-hydrated ions, peptides and other organic compounds. Preferably, the analyte are selected from the group consisting of a perfluoroalkylsulfonate ion, an alkylsulfate ion, a carborane monoanion, tetrafluoroborate, hexafluorophosphate, perchlorate, pertechnetate, perrhenate, cyanide, cyanate, thiocyanate, a monoalkyl ester of deprotonated alkylphosphonic acid, bisulfate, a peptide, an antibiotic (e.g., penicillin-G), perfluorocarboxylate, nitrite, chlorate, and azide.

In one particular embodiment of the present invention, the analyte affinity compound is useful in detecting an anion, preferably a weakly-hydrated ion. Preferably, anion is selected from the group consisting of perfluoroalkylsulfonates, alkylsulfates, carborane monoanions, tetrafluoroborate, hexafluorophosphate, perchlorate, pertechnetate, perrhenate, cyanide, cyanate, thiocyanate, monoalkyl esters of deprotonated alkylphosphonic acids, bisulfate, perfluorocarboxylates, nitrite, chlorate, azide, Penicillin-G.

### BRIEF DESCRIPTION OF THE DRAWINGS

FIG. 1 is an IR spectrum of an aqueous solution of 1 mM Li⁺CF₃SO₃⁻ using an unmodified (i.e., without any analyte affinity compound), SiComp® (silicon) attenuated total reflectance (ATR) sensing element; and

FIG. 2 is an IR spectrum of an aqueous solution of 1 mM Li⁺CF₃SO₃⁻ using a modified (i.e., with HEP⁺NO₃⁻ as an analyte affinity compound), SiComp® (silicon) attenuated total reflectance (ATR) sensing element.

### DETAILED DESCRIPTION OF THE INVENTION

“Aryl” groups are monocyclic or bicyclic carbocyclic or heterocyclic aromatic ring moieties. Aryl groups can be substituted with one or more substituents, such as a halogen, alkenyl, alkyl, alkynyl, hydroxy, amino, thio, alkoxy or cycloalkyl. Exemplary aryl groups include pyrrole, thiophene, furan, imidazole, pyrazole, 1,2,4-triazole, pyridine, pyrazine, pyrimidine, pyridazine, thiazole, isothiazole, oxazole, isoxazole, s-triazine, benzene, indene, isoindene, benzofuran, dihydrobenzofuran, benzothiophene, indole, 1H-indazole, indoline, azulene, tetrahydroazulene, benzopyrazole, benzoxazole, benzoimidazole, benzothiazole, 1,3-benzodioxole, 1,4-benzodioxan, purine, naphthalene, tetralin, coumarin, chromone, chromene, 1,2-dihydrobenzothiopyran, tetrahydrobenzothiopyran, quinoline, isoquinoline, quinazoline, pyrido[3,4-b]-pyridine, and 1,4-benisoxazine.

“Alkyl” means a linear or branched saturated monovalent hydrocarbon radical of one to twenty carbon atoms, e.g., methyl, ethyl, propyl, 2-propyl, n-butyl, iso-butyl, tert-butyl, pentyl, hexyl, 2-methylhexyl, 2-methylnonyl, and the like.

Unless the context requires otherwise, the term “coated” refers to attachment of an analyte affinity compound to a detection probe by any physical or chemical means. Therefore, coating can include attachment of the analyte affinity compound and the detection probe through a covalent or ionic bond formation; hydrophilic, hydrophobic or Van der Waals force interaction between the analyte affinity compound and the detection probe; as well as any other known methods including coating a polymer containing the analyte affinity compound onto the detection probe or generating a sol-gel-derived material containing the analyte affinity compound.

The present invention provides a method and a device for detecting a presence of or quantifying the amount of an analyte in a fluid medium. As used in this invention, a “fluid medium” refers to a gas or a liquid, preferably a liquid, and more preferably an aqueous solution. In one particular embodiment, the present invention is directed to increasing the relative concentration of the analyte proximal to a detection probe ATR crystal relative to the concentration of the analyte in the fluid medium. In this manner, the sensitivity of the detection probe is greatly increased; thus, allowing qualitative and/or quantitative analysis of the analyte in the fluid medium.

As used herein, a “detection probe” refers to a device which is used for detecting or sensing (i.e., a device which sends back information regarding) the presence, quantity or identity of the analyte in a fluid medium. Thus, a detecting probe is a device which sends and/or receives information to and from the fluid medium and communicates with an analytical device. Alternatively, a detecting probe can comprise two separate units in which one of the units is used to send information to the fluid medium and the other is used to receive information from the fluid medium.

The detection probes of the present invention detect a variety of signals including electromagnetic waves, such as radio waves, infrared waves, visible waves and ultraviolet waves; electric signals, such as conductivity, capacity and resistivity; and electrical current as a function of electrical potential. Preferably, detection probes of the present invention detect infrared waves, electrical current as a function of electrical potential, or electronic conductivity.

Detection probes of the present invention can be used to determine the presence of or to quantify the amount of a variety of analytes, particularly, weakly-hydrated ions. As used herein, a “weakly-hydrated ion” refers to an ion with an enthalpy of hydration less negative than that of the nitrate anion. Exemplary weakly-hydrated ions include ions containing a lipophilic moiety such as hydrocarbylsulfonates, for example, perfluoroalkylsulfonates (e.g., CₙF₂ₙ₊₁SO₃⁻); hydrocarbylsulfates, hydrocarbylphosphates; hydrocarbylphosphonates; and hydrocarbylcarboxylates. As used herein, a “hydrocarbyl” refers to a hydrocarbon compound or a moiety which can be straight, a branched chain group or a ring. Hydrocarbyls optionally can be substituted with one or more substituents, such as a halogen, alkenyl, alkynyl, aryl, hydroxy, amino, thio, alkoxy, carboxy, oxo or cycloalkyl. There may be optionally inserted along the alkyl group one or more oxygen, sulfur or substituted or unsubstituted nitrogen atoms.

Particular aspects of the present invention will now be described in the context of attenuated total reflection Fourier-transform infrared (ATR FT-IR) sensing element, i.e., waveguide or detection probe, for detecting the presence of, or the quantity of, perfluoroalkylsulfonate anions (PFS anions) in an aqueous solution. Such descriptions are not intended to limit the general applicability of the present invention to only detecting PFS anions in an aqueous solution using ATR FT-IR.

A quantitative or qualitative analysis of PFS anions in an aqueous solution can be achieved by using an ATR FT-IR instrument and observing the sulfur-oxygen and/or carbon-fluorine stretching region of the infrared (IR) spectrum of the aqueous solution. However, when the amount of PFS anions present in water is low, the IR signals are weak, thus making the IR analysis difficult. The present invention overcomes this limitation by providing an ATR sensing element which comprises an analyte affinity compound that has a higher affinity for PFS anions than it has for the nitrate or chloride anion. The analyte affinity compound on the ATR sensing element increases the effective concentration of PFS anions on the ATR sensing element by PFS anion/nitrate anion exchange, thereby leading to a stronger IR signal for the PFS anion. It should be appreciated that the presence of the analyte affinity compound on the ATR sensing element does not increase the total amount of PFS anions in the aqueous sample but rather provides a higher local concentration of PFS anions on the ATR sensing element relative to the concentration of PFS in the aqueous solution.

The analyte affinity compound can be placed onto the ATR sensing element temporarily or permanently. In one embodiment of the present invention, the analyte affinity compound is placed onto the ATR sensing element permanently by a covalent bond. Moreover, the analyte affinity compound can be placed onto the ATR sensing element by using a linker which is covalently bonded to the analyte affinity compound and the ATR sensing element. Forming a covalent bond between the analyte affinity compound and the ATR sensing element can be achieved by using a variety of methods known in the art. For example, for an ATR sensing element which has silicon oxide on its surface, the surface can be relatively easily modified by using a wide variety of commercially available silanizing agents such as tetraalkyl orthosilicates, such as tetramethyl orthosilicate (Si(OCH₃)₄) and tetraethyl orthosilicate (Si(OC₂H₅)₄); tetrachlorosilane (SiCl₄); alkyltrichlorosilanes (RSiCl₃); alkyltrialkoxysilanes (RSi(OR′)₃); dialkyldichlorosilanes (R₂SiCl₂); and dialkyldialkoxysilanes (R₂Si(OR′)₂). Exemplary methods of placing a polymer onto an ATR sensing element are disclosed in numerous references, including by Han et al., Applied Spectroscopy, 1998, 52, 119-122; Regan et al., Anal. Chim. Acta., 1996, 334, 85-92; Lee and Saavedra, Anal. Chim. Acta., 1994, 285, 265-269; Taga et al., Anal. Chem., 1994, 66, 35-39; Ruddy and McCabe, Applied Spectroscopy, 1990, 44, 1461-1463; Wexler et al., Chem. Mater., 1995, 7, 1583-1588; Ferrer et al., Mikrochim. Acta. Suppl., 1997, 14, 297-299; Kujawski et al., J. Appl. Polymer Sci., 1992, 44, 951-958; and Kubicki et al., Environ. Sci. Technol., 1997, 31, 1151-1156, all of which are incorporated herein by reference in their entirety.

Covalent modification can be performed directly on the surface of the ATR crystal. See for example, Mizaikoff et al. “FTIR-microspectroscopic investigation of chemisorbed silanes on IR-transparent materials,” Fresenius J. Anal. Chem. 1993, 346, 355-357, which is incorporated herein by reference in its entirety. By first hydroxylating the surface of a silicon ATR crystal with a strong base (e.g., NaOH or KOH), the hydroxylated surface can then be reacted with an appropriately modified analyte affinity molecule. Such modified analyte affinity molecules typically contain functional groups such as siloxy (Si—OR), chlorosilyl (Si—Cl), or other reactive moieties, which are known to readily react with hydroxylated silicon surfaces. An example of such a reaction is illustrated below.

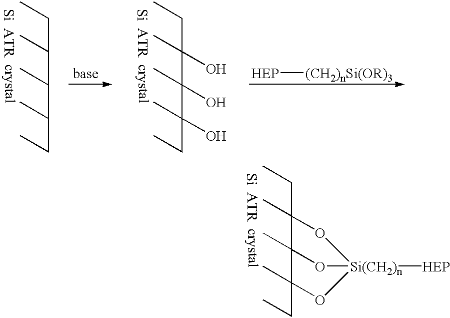

Alternatively, the analyte affinity compound can be attached to the ATR crystal (or film) as a composite material of an analyte affinity compound chemically bonded or physically trapped in a layer of nanoporous SiO₂ or another metal oxide prepared using sol-gel techniques. This sol-gel coating comprising an analyte affinity compound can vary in thickness from a fraction of a micron to several microns, depending on the application.

There are several examples of ATR crystals being modified using the sol-gel method. See for example, Yang et al., “Fabrication and characterization of low-loss, sol-gel planar waveguides,” Anal. Chem. 1994, 66, 1254-63; Yang et al. “Chemical sensing using sol-gel derived planar waveguides and indicator phases,” Anal. Chem. 1995, 67, 1307-14; Wexler et al. “Conductive thin-film composite hydrogels: trapping anionic polyelectrolytein polyaziridine host matrix,” Chem. Mater. 1995, 7, 1583-8; and Lu et al. “Chemical sensors based on hydrophobic porous sol-gel films and ATR-FTIR spectroscopy,” Sens. Actuators, B 1996, B36, 517-521, all of which are incorporated herein by reference in their entirety. A general method for preparation of sol-gel coated crystals by a variety of silanizing agents, such as RSi(OR′)₃, R₂Si(OR′)₂, Si(OR′)₄, SiCl₄, and similar compounds (R, R′=Me, Et, alkyl), are described below.

A sol-gel is prepared by mixing appropriate ratios of silanizing agent(s), water, acid and analyte affinity compound (HEP, DEC, other) together. This gel is allowed to condense for an appropriate amount of time before coating onto the surface of the ATR crystal. Coating can be done by a variety of methods including spin coating, dip coating, or drop coating. Upon coating, the crystal can be heated to promote further condensation of the gel, which results in the final, porous coating. The final coating contains the analyte affinity compound, which is trapped in the pores of the sol-gel.

Furthermore, ATR surfaces can also be modified using a combination of sol-gel and surface modification techniques described above. See for example, Han et al. “Chemical sensors based on surface-modified sol-gel-coated infrared waveguides,” Appl. Spectrosc., 1998, 52, 119-122, which is incorporated herein by reference in its entirety. A sol-gel layer (without analyte affinity compound) can be attached to a crystal as described above. The sol-gel layer, which has Si—OH moieties on the surface and in the pores, is then covalently modified with the same modified analyte affinity compound used for the direct surface modification described above.

Still alternatively, the analyte affinity compound can be attached to the ATR crystal as a composite material of an analyte affinity compound chemically bonded or physically trapped in a layer of an organic or inorganic polymer. The attached composite material can vary in thickness from a fraction of a micron to several microns, depending on the application. The polymers used can be simple “carriers” for the analyte affinity compound or they can be designed to enhance the sensitivity of the coating for particular analytes.

Preferably, the analyte affinity compounds are redox-recyclable. As used herein, a “redox-recyclable” refers to an analyte affinity compound which can be deactivated and reactivated by reduction and oxidation. For example, typically the analyte affinity compound is a neutral compound which can be oxidized to yield a cation form with a corresponding anion. When this oxidized analyte affinity compound is contacted with an aqueous solution containing PFS anions, it undergoes exchange of anions, thereby concentrating PFS anions onto the ATR sensing element. After the analysis, PFS anions can be removed from the ATR sensing element by simply reducing (i.e., deactivating) the analyte affinity compound to regenerate the neutral analyte affinity compound. In this manner, the ATR sensing element can be activated and deactivated rapidly and can be reused repeatedly.

The analyte affinity compounds of the present invention can be reduced or oxidized using a chemical or electrochemical means. Exemplary chemical oxidizing agents include ferric nitrate, peroxide ion, hydrogen peroxide, hypochlorite ion (e.g., household bleach), and cerium (IV) compounds. Preferably, the oxidizing agent is selected from the group consisting of ferric chloride, silver salts, ferric nitrate, hypochlorite ion, and cerium (IV) compounds, more preferably from the group consisting of ferric nitrate and cerium (IV) compounds, and most preferably the chemical oxidizing agent is ferric nitrate. Exemplary chemical reducing agents include ferricyanide ion, dithionite ion, zinc and other active metals, and borohydride ion. Preferably, the reducing agent is selected from the group consisting of ferricyanide ion, dithionite ion, and zinc, more preferably from the group consisting of ferricyanide ion and dithionite ion, and most preferably from the group consisting of dithionite ion. It should be appreciated that when a cation analysis is desired, an appropriate analyte affinity compound is reduced to produce an anion with a corresponding cation.

The activated analyte affinity compound can be composed of a cation analyte affinity compound instead of an anion analyte affinity compound, such as HEP⁺N₃⁻ and DEC⁺NO₃⁻. Exemplary cation analyte affinity compound include Na[Fe(η⁵-C₅H₅)(η⁵-(3)-1,2-C₂B₉H₉(n-C₁₂H₂₅)₂)](Na⁺I⁻) and Na[Fe(η⁵-C₅H₅)(η⁵-(3)-1,2-C₂B₉H₇(n-C₁₂H₂₅)₂-9,12-Br₂)], which described in Clark et al., “Design and Use of Redox-Recyclable Organometallic Extractant for the Cationic Radionuclides ¹³⁷Cs⁺ and ⁹⁰Sr²⁺,” Environ. Sci. Technol. 1999, 33, 2489-2491, which is incorporated herein by reference in its entirety.

The analyte affinity compounds of the present invention are selected depending on a particular analyte to be analyzed. Generally, analyte affinity compounds are organometallic compounds (e.g., transition-metal complexes) that are stable as neutral complexes and as one-electron oxidized or reduced cations or anions. The analyte affinity compounds of the present invention are kinetically inert to substitution in both redox states. Preferably analyte affinity compounds include polydentate ligands. Moreover, it is also preferred that the analyte affinity compounds do not contain acid-or base-labile functional groups. In addition, they have redox potentials that allow the use of simple, inexpensive oxidants or reductants and undergo rapid one-electron oxidation or reduction. However, they do not undergo over-oxidation or over-reduction in the presence of an excess of oxidant or reductant. Preferably, the analyte affinity compounds are relatively nontoxic (e.g., iron complexes are preferred to chromium complexes). In addition, they are relatively inexpensive (e.g., iron complexes are preferred to ruthenium complexes). Furthermore, the analyte affinity compounds have negligible water solubility in both working oxidation states.

In one particular aspect of the present invention for analyzing weakly-hydrated anions, such as PFS anions, the ionized analyte affinity compound (i.e., activated analyte affinity compound) is selected from salts of large, lipophilic cations having small hydrophilic counter anions. Without being bound by any theory, it is believed that the large lipophilic analyte affinity compound increases the selectivity of the analyte affinity compound for a large counterion that is to be detected. In one particular embodiment of the present invention, the analyte affinity compound is a compound of Formula I shown above. Preferably, the analyte affinity compound is 1,1′,3,3′-tetrakis(2-methyl-2-hexy)ferricenium cation (HEP⁺), 1,1′,3,3′-tetrakis(2-methyl-2-nonyl) ferrocenium cation (DEC⁺) which contains small hydrophilic counter anions such as nitrate (NO₃⁻) or chloride (Cl—), Ni(DPPP)Cl₂ or the Eu/styrene MIP. More preferably, the analyte affinity compound is 1,1′,3,3′-tetrakis(2-methyl-2-hexyl)ferricenium cation (HEP⁺), 1,1′,3,3′-tetrakis(2-methyl-2-nonyl)ferrocenium cation (DEC⁺) which contains small hydrophilic counter anion.

Preferably, the amount of analyte affinity compound attached onto the surface of the ATR sensing element allows sufficient interaction between the analyte affinity compound and aqueous PFS anions, thereby increasing the PFS anion concentration in the region sampled by the evanescent wave by the ATR sensing element. The lipophilic portion of the analyte affinity compound serves to reduce or eliminate water from the region sampled by the evanescent wave, which reduces IR radiation absorption by water molecules. For PFS anion analysis using HEP⁺NO₃⁻ as the activated analyte affinity compound, a thin film of from about 0.3 μm to about 2 μm thickness of the analyte affinity compound is preferred.

By using a detection probe coated (i.e., attached) with the analyte affinity compound of the present invention, the sensitivity of the detection probe can be increased by a factor of at least about 10 compared to a detection probe which does not comprise attached analyte affinity compound. Preferably, the sensitivity of the detection probe of the present invention is increased by a factor of at least from about 100 and about 1000, more preferably by a factor of at least about 10,000, and most preferably by a factor of at least about 100,000.

Additional objects, advantages, and novel features of this invention will become apparent to those skilled in the art upon examination of the following examples thereof, which are not intended to be limiting.

### EXAMPLES

General Procedure

HEP⁺NO₃⁻ can be prepared using the procedure disclosed in Clark et al., Environ. Sci. Technol., 1996, 30, 3124-3127 and references cited in Chambliss et al., Anal. Chem., 1998, 70, 757-765, all of which are incorporated by reference herein in their entirety.

An ATR sensing element can be coated with temporary film of HEP⁺NO₃⁻ by contacting the ATR sensing element with a dichloromethane solution of HEP⁺NO₃₋ and evaporating the solvent.

IR absorbance was measured using ASI React 1000 FTIR spectrometer (Millersville, Md.) with a “30 bounce” SiComp® (silicon) probe.

The particular ATR probe that was used for these experiments has approximate dimensions shown in the figure below.

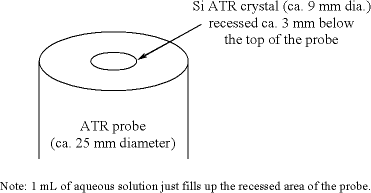

### Example 1

This example shows comparison of IR absorbances by 1 mM aqueous solution of Li⁺CF₃SO₃⁻ between an ATR IR sensing element coated with HEP⁺NO₃⁻ and an ATR IR sensing element that is not coated with HEP₊NO₃⁻.

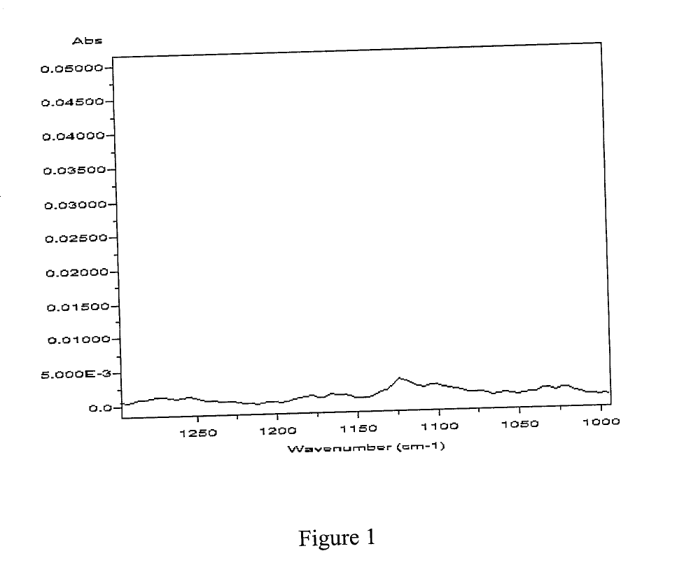

About 1 mL of an aqueous solution of 1 mM Li⁺CF₃SO₃⁻ was placed on the unmodified (i.e., not coated with HEP⁺NO₃⁻) SiComp® (silicon) ATR sensing element and IR absorbance of the solution was measured. A spectrum of water was taken as the background. The resolution was set to 8 cm⁻¹ with 128 scans for the Fourier transform function. At these instrumental settings and concentration, there are no noticeable peaks that are characteristic of the triflate molecule. There are four peaks (1266, 1227, 1155, 1034 cm⁻¹) that are unique to triflate from both the C—F and S—O stretching vibrations of the molecule. As shown in FIG. 1, the IR spectrum had a poor signal to noise ratio, and the absorbance at about 1266 cm⁻¹ was about 1×10⁻³.

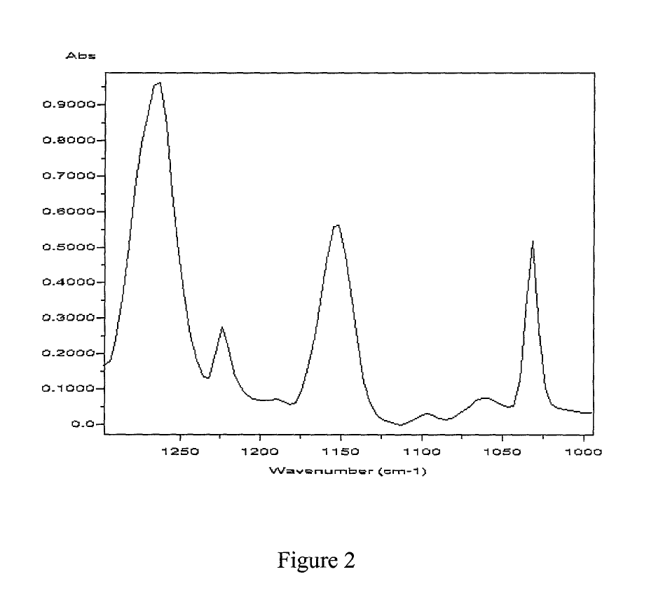

The procedure was repeated using the ATR sensing element coated with a thin film of HEP⁺NO₃⁻. The sensor was coated with a film evaporated from 0.025 mL of a 1 mM HEP⁺NO₃⁻ solution in dichloromethane (ACS grade). The resolution was set to 8 cm⁻¹ with 128 scans for the Fourier transform function. As shown in FIG. 2, the absorbance of the solution at about 1266 cm⁻¹ grew to more than 0.9 within 15 minutes.

Comparison of IR absorption peak at about 1340 cm⁻¹ (not shown) indicated a corresponding decrease in the IR peak at 1340 cm⁻¹ due to decrease in NO₃⁻ anion concentration near the ATR sensing element. It is believed that when an aqueous solution of 1 mM Li⁺CF₃SO₃⁻ is placed in contact with the thin film of HEP⁺NO₃⁻ an anion exchange takes place according to the following equation:

HEP⁺NO₃⁻(s)+CF₃SO₃⁻(aq)→HEP⁺CF₃SO₃⁻(s)+NO₃⁻(aq)

The exchange of CF₃SO₃⁻ for NO₃⁻ is essentially complete because of the selectivity of the HEP⁺ cation for large weakly-hydrated anions like CF₃SO₃⁻ (and other PFS anions) over small strongly-hydrated anions such as NO₃⁻.

The detection limit of an FTIR spectrometer for a PFS anion such as CF₃SO₃⁻ can be increased by a factor of about 10³ using the present invention. Other weakly-hydrated anions which can be detected by methods of the present invention include, but are not limited to, TcO4⁻, ReO₄⁻, and ClO₄⁻.

### Example 2

This example illustrates the recyclability of the device.

The film of HEP⁺NO₃⁻, after undergoing ion-exchange with an aqueous solution of Li₊CF₃SO₃⁻ was reduced with aqueous K₄Fe(CN)₆, releasing the CF₃SO₃⁻ ions and any remaining NO₃⁻ ions from the film. The film of neutral HEP was then re-oxidized (reactivated) to HEP⁺NO₃⁻ with aqueous Fe(NO₃)₃ in 0.1 M HNO₃.

### Example 3

This example illustrates redox-recycling of the analyte affinity compound in the ATR coating.

A film of DEC⁺CB₁₁,H₁₂⁻ was deposited on the silicon ATR crystal from a dichloromethane solution of the compound. This compound exhibits an intense ν(BH) band in the IR spectrum at 2540 cm⁻¹. After evaporation of dichloromethane, the film-coated crystal was treated with 1 mL of an aqueous solution containing ca. 0.1 M Na₂S₂O₄, a strong reducing agent. IR spectra showed that the intense band at 2540 cm⁻¹ decreased over time while the intensities of other bands due to the DEC analyte affinity compound remained constant over time. This is shown in the figure below.

[image]

The two bands identified by arrows are at 2930 cm⁻¹ (a ν(CH) band of the DEC⁺ moiety) and at 2540 cm⁻¹. These spectra indicate that DEC⁺CB₁₁, H₁₂⁻ in the ATR coating is reduced to DEC with concomitant release of the CB₁₁, H₁₂⁻ anion to the aqueous solution. This process, shown in the chemical equation below, represents the deactivation step of an analyte affinity compound-containing ATR crystal coating:

2DEC+CB₁₁H₁₂⁻(s)+S₂O₄⁻²(aq)+2H₂O→2DEC(s)+2CB₁₁H₁₂⁻(aq)+2H₂SO₃(aq)

After the ν(BH) band of CB₁₁, H₁₂⁻ at 2540 cm⁻¹ had all but decayed down to the baseline, the film was treated with 1 mL of an aqueous solution containing 0.1 M Fe(NO₃)₃ (an oxidizing agent) and ca. 10 mM Cs⁺CB₁₁H₁₂₋. IR spectra showed that the 2540 cm⁻¹ band grew back in over time as the film was reactivated (i.e., as the DEC analyte affinity compound was reoxidized to DEC⁺), as shown in the figure below. Note that in the figure, the reactivation step and the concomitant detection of aqueous CB₁₁H₁₂⁻ were combined into one step in this example.

[image]

The reactivation/detection process is depicted in the following chemical equation below:

DEC(s)+Fe⁺³(aq)+CB₁₁H₁₂⁻(aq)→DEC⁺CB₁₁H₁₂⁻(s)+Fe⁺²(aq)

### Example 4

This example illustrates detection of 1 mM aqueous PMPA .

This anion, the structure of which is shown below, is the initial hydrolysis product of the organophosphorus nerve agent GD and is related to the hydrolysis products of other organophosphorus nerve agents such as GA, GB, and VX. Their detection in aqueous media is an important challenge to the U.S. Department of Defense.

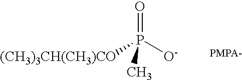

A film of DEC⁺HSO₄⁻ was deposited on the ATR crystal from a dichloromethane solution of the compound. After evaporation of dichloromethane, the probe was treated with 1 mL of an aqueous solution containing 1 mM PMPA⁻. Two of the IR bands of the PMPA⁻ anion at 1204 and 1065 cm⁻¹ were observed by IR spectroscopy within 2 min. Significantly, these two bands were not observed (i.e., 1 mM PMPA⁻ was not detected) when the uncoated silicon ATR probe was used. The two bands continued to increase in intensity over time. This example demonstrates that the PMPA⁻ anion can be detected in aqueous media at concentrations below which the anion cannot be detected using an uncoated ATR crystal.

### Example 5

This example illustrates an alternative detection of 1 mM aqueous PMPA⁻.

A film of DEC⁺Cl⁺ was deposited on the ATR crystal from a dichloromethane solution of the compound. After evaporation of dichloromethane, the probe was treated with 1 mL of an aqueous solution containing 1 mM PMPA⁻ plus 2 mM acrylamide. IR bands of the acrylamide/PMPA⁻ complex at 1177, 1085, 1061, 1040, 1015, 961 cm⁻¹ were observed within 2 min. These bands, as well as others, continued to increase in intensity over time, as shown in the figure below.

[image]

As in Example 4, the PMPA⁻ bands were not observed when an uncoated silicon ATR probe was treated with the same aqueous solution.

### Example 6

This example illustrates detection of 1.8 ppm aqueous PMPA⁻ using Eu/styrene co-polymer films.

Preparation of Eu/styrene Co-polymer Films

The compound, [Eu(DVMB)₃(NO₃)₂PMPA], was prepared according to procedures described by Nassar et al. in “Quantitative Analysis of Chemical Warfare Agent Degradation Products in Reaction Masses Using Capillary Electrophoresis,” Anal. Chem. 1998, 70, 3598-3604, which is incorporated herein by reference in its entirety. Styrene was then mixed with [Eu(DVMB)₃(NO₃)₂PMPA] in a 5:1 (mol:mol) mixture respectively, and diluted with 10 mL of toluene. After addition of 1 mol % AIBN, the resulting suspension was placed in a sonication bath at 60° C. After 30 minutes, the clear, viscous solution was removed from the sonication bath. One drop of the solution was then applied to the surface of a Di-comp®, ATR-FTIR dura disk® probe. The drop spread across the diamond surface covering the entire crystal. The coated probe was then placed under a UV lamp and allowed to cure for 2 hours. The resulting white polymer film had a red color when held under high wavelength UV light.

Composite Film Extraction/Detection Studies

The Eu/styrene film was washed with 1 M nitric acid for 30 minutes to remove PMPA⁻. The film was then washed for another 30 minutes with 1 M hydrochloric acid. The film was then allowed to equilibrate with deionized water for 15 minutes before a detection experiment was started.

Detection experiments were performed by first collecting a background spectrum of the extraction film equilibrated with water. An appropriate amount of analyte was then added to the water and spectra recorded every minute for 2 hours. After the completion of the detection experiment, the film was recycled by washing with 1 M hydrochloric acid for 30 minutes, followed by a 15-minute equilibration with deionized water. Subsequent detection experiments were then performed with a recycling step between each detection experiment.

Phosphonate Detection with Eu/styrene Composite Films

Results showed that removal and addition of PMPA⁻ in the Eu/styrene composite films can be monitored by ATR FTIR in the manner similar to those described by Mesilaakso et al. in “Detection of Trace Amounts of Chemical Warfare Agents and Related Compounds in Rubber, Paint, and Soil Samples by ¹H and ³¹P{¹H} NMR Spectroscopy,” Anal. Chem. 1996, 68, 2313-2318, which is incorporated herein by reference in its entirety. The figure below shows spectra of a molecularly imprinted polymer material (i.e., MIP-film) before and after exposure to a 1.80 ppm (10 μM) aqueous PMPA solution. Spectra were taken at 0 and 70 minutes. The peaks at 1146 cm⁻¹, 1100 cm⁻¹, 1069 cm⁻¹, and 1046 cm⁻¹ are characteristic v(P—O) bands for PMPA⁻ bound to a Eu center.

[image]

The surface of the ATR FTIR sensing crystal can also be derivatized before deposition of the Eu/styrene MIP film. Prior modification of the ATR crystal surface can yield a substrate that is useful for film deposition. One example is modification of a silicon crystal with a vinyl-functionalized silane. Such functionality allows for polymerization directly to the ATR-crystal surface, as shown below:

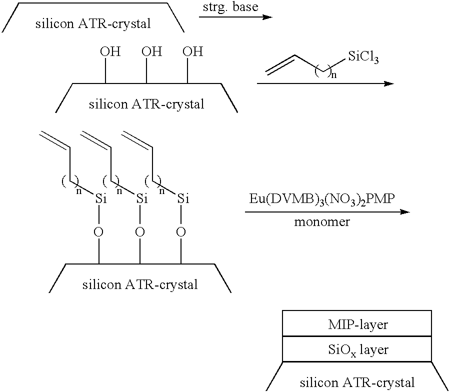

MIP film on the ATR sensing crystal surface can lead to a better film stability and more efficient means of evaluating the MIP film's ATR FTIR sensing capabilities. Other method for achieving film adhesion is the use of monomers other than styrene. One class of suitable monomers include acrylates. Acrylates such as methyl methacrylate are softer polymers than styrene and in some instances adhere better to crystalline surfaces than styrene. For these reasons, a variety of co-monomers can be used for co-polymerization with the Eu(DVMB)₃(NO₃)₂PMPA complexes.

### Example 7

This example illustrates another method for detecting PMPA⁻ at a concentration of 1.8 ppm in an aqueous solution.

Several salts of the polyalkylated ferrocene DEC were prepared and deposited as thin films on the surface of ATR FTIR crystals as pre-concentrating media for the detection of phosphonates. Salts tested included DEC⁺Cl⁻, DEC⁺F⁻, and DEC⁺ acetate⁻.

The compound DEC⁺F⁻ was deposited as a thin film from dichloromethane onto a diamond ATR FTIR sensing crystal and detection of a 1.8 ppm (10 μM) aqueous solution PMPA⁻ was performed in the manner described in Example 6. Spectra at 0 minutes and 15 minutes are shown in the figure below.

[image]

As shown in the figure, PMPA⁻ is easily detected at a level of 1.8 ppm in 15 minutes. The peaks seen at 1181 cm⁻¹, 1061 cm^{31 1}, 1046 cm⁻¹, and 1015 cm⁻¹ are characteristic v(P—O) bands for PMPA⁻. The detection limit of 1.8 ppm is at least ten 5 times lower than that achieved for DEC⁺Cl⁻.

### Example 8

This example illustrates detection of 0.1 mM aqueous PMPA⁻.

A film of DEC⁺Cl⁻ was deposited on the ATR crystal from a dichloromethane solution of the compound. After evaporation of dichloromethane, the probe was treated with 100 mL of an aqueous solution containing 0.1 mM PMPA⁻ (this corresponds to 18 ppm PMPA⁻). Six of the IR bands of the PMPA anion, at 1177, 1089, 1061, 1045, 1015, and 961 cm⁻¹, were observed within minutes. After 30 minutes, a difference spectrum was recorded (the spectrum that was subtracted was that of the DEC⁺Cl⁻ coating at the start of the experiment). This spectrum is shown below.

[image]

The six PMPA⁻ bands are clearly seen. The maximum absorbance of the most intense bands, at 1177 and 1045 cm⁻¹, are 0.060 and 0.074, respectively. The lower spectrum in the figure below is the spectrum of a 10 mM aqueous solution of PMPA⁻ (i.e., the free acid at pH 7.3) with an uncoated silicon ATR probe. Note that the bands of the PMPA⁻ anion are barely visible in the lower spectrum even though the concentration of the anion is at least about 100 times greater than in the experiment with the coated ATR probe. The spectrum of 10 mM aq. PMPA7 with an expanded vertical scale is shown below.

[image]

### Example 9

This example illustrates detection of 0.01 mM aqueous PMPA⁻.

A film of DEC⁺Cl⁻ was deposited on the ATR crystal from a dichloromethane solution of the compound. After evaporation of dichloromethane, the probe was treated with 100 mL of an aqueous solution containing 0.01 mM PMPA⁻ (this corresponds to 2 ppm PMPA⁻). Six of the IR bands of the PMPA⁻ anion, at 1177, 1089, 1061, 1045, 1015, and 961 cm⁻¹, were observed within minutes. After 10, 30 and 60 minutes, difference spectra were recorded (the spectrum that was subtracted was that of the DEC⁺Cl⁻ coating at the start of the experiment). These three difference spectra are shown below. The lowest trace is the 10 minute difference spectrum; the highest trace is the 60 minute difference spectrum. Note that 2 ppm aq. PMPA⁻ can be detected in 10 minutes.

[image]

### Example 10

This example illustrates quantitation of μM concentrations of CF₃SO₃⁻.

A film of DEC⁺NO₃⁻ was deposited on the ATR crystal from a dichloromethane solution of the compound. After evaporation of dichloromethane, the probe was treated with 100 mL of an aqueous solution containing 0.1, 1, 5, 10, or 15 μM CF₃SO₃⁻ (lithium salt). The intensity of one of the IR bands of the CF₃SO₃ ion, at 1266 cm⁻¹ was monitored over time. Significantly, the final intensity of the CF₃SO₃ bands are not proportional to the concentration of the analyte, because the film of analyte affinity compound has such a high selectivity for weakly hydrated anions that NO₃⁻/CF₃SO₃⁻ ion exchange was complete a at nearly all concentrations of CF₃SO₃⁻. In order to obtain concentration information using methods of the present invention, the rate of change of the absorbance with time for the initial linear portion of an A vs. t plot (see figure on the left below) versus concentration was plotted as shown in the figure on the right below.

[image]

The linear nature of this plot can be used as a calibration curve to determine an unknown concentration of CF₃SO₃⁻ in the 0.1-15 μM concentration range (note that 0.1 CF₃SO₃⁻ corresponds to 15 ppb CF₃SO₃⁻). Importantly, when the 15 μM CF₃SO₃⁻ experiment was repeated with a 10-fold excess of NaNO₃ added to the aqueous sample, the dA/dt value was unchanged. This demonstrates that the calibration curve can be used even when other, more strongly hydrated ions, are present in the aqueous sample.

### Example 11

This example illustrates detection of 15 ppb aqueous ClO₄⁻.

The perchlorate anion is a groundwater contaminant of growing concern. The U.S. EPA has just finalized the new standard method, based on ion chromatography, for the determination of perchlorate in drinking water. There is no published method based on IR spectroscopy for determining ppm and lower concentrations of ClO₄⁻ in water. There are many advantages of analyte affinity compound-ATR-FTIR detection over ion chromatographic detection of ClO₄⁻¹ in water including:

(1) the ν(ClO) band at 1094 cm⁻¹ is directly observed, so false readings due to a similar retention time for a co-contaminant are avoided;

(2) sample pre-treatment is avoided (this is frequently necessary for ion chromatography when the ionic strength of the sample is high); and

(3) the probe can be quickly (within minutes) deactivated and reactivated for the next sample.

A film of DEC⁺NO₃⁻ was deposited on the ATR crystal from a dichloromethane solution of the compound. After evaporation of dichloromethane, the probe was treated with 1 mL of an aqueous solution containing 15 ppb ClO₄⁻ (potassium salt). The intensity of the IR band due to the NO₃⁻ ion in the film decreased over time while the ν(ClO) IR band at 1092 cm⁻¹ grew in over time, as shown in the difference ATR-FTIR spectra displayed in the figure below.

[image]

The ν(ClO) band due to ClO₄⁻ grows in at 1092 cm⁻¹ because ClO₄⁻ is accumulating in the film (i.e., it is undergoing selective ion exchange with NO₃⁻ originally in the film). The negative band at 1360 cm⁻¹ is the ν(NO) band of NO₃⁻, which is partitioning from the film into the aqueous sample. Since the detection limit of ClO₄⁻ with the uncoated silicon ATR crystal is 230,000 ppb, this example demonstrates that a lowering of the detection limit by a factor of more than 10,000 is achieved using the analyte affinity compound-containing coatings on FTIR ATR crystals.

### Example 12

This example illustrates detection of 3 ppb aqueous ClO₄⁻.

A film of DEC⁺NO₃⁻ was deposited on the ATR crystal from a dichloromethane solution of the compound. After evaporation of dichloromethane, the probe was treated with 100 mL of an aqueous solution containing 3 ppb ClO₄⁻ (lithium salt). The intensity of the IR band due to the NO₃⁻ ion in the film decreased over time while the ν(ClO) IR band at 1096 cm⁻¹ grew in over time, as shown in the difference ATR-FTIR spectra displayed in the figure below.

[image]

The ν(ClO) band due to ClO₄⁻ grows in at 1096 cm⁻¹ because ClO₄⁻ is accumulating in the film (i.e., it is undergoing selective ion exchange with NO₃⁻ originally in the film). The negative band at 1351 cm⁻¹ is the ν(O) band of NO₃⁻, which is partitioning from the film into the aqueous sample. Since the detection limit of ClO₄⁻ with the uncoated silicon ATR crystal is about 230,000 ppb, this example demonstrates that a lowering of the detection limit by a factor of more than about 76,000 is achieved using coatings containing an analyte affinity compound on FTIR ATR crystals.

### Example 13

This example illustrates detection of a low concentration of ethyl methyl phosphonate (i.e., EMPA⁻) using a DEC⁺F⁻ film.

The detection limit was determined to be 12.4 ppm (100 μM). Though higher than the detection limit for PMPA⁻, this detection limit is still an improvement over DEC⁺Cl⁻, which was unable to detect EMPA⁻ at any concentration. Spectra for the detection of EMPA⁻ at 0 minutes and 12 minutes are shown in the figure below. The peaks seen at 1177 cm⁻¹, 1046 cm⁻¹, and 946 cm⁻¹ are characteristic v(P—O) bands for EMPA⁻.

[image]

The compound DEC⁺acetate⁻ was also used for the detection of PMPA⁻. The detection limit achieved using this compound was also 1.8 ppm.

### Example 14

This example illustrates quantification of μM concentrations of ClO₄⁻ from a complex matrix.

A film of DEC⁺NO₃⁻ was deposited on the ATR crystal from a dichloromethane solution of the compound. After evaporation of dichloromethane, the probe was treated with 100 mL of an aqueous solution containing a high nitrate fertilizer containing a small unknown concentration of perchlorate. The IR spectra below shows perchlorate (1096 cm⁻¹) after 0, 15, 30, and 60 minutes being extracted from a 100 ppm nitrate fertilizer matrix.

[image]

The concentration of perchlorate in the fertilizer matrix can be determined using a standard addition of known concentrations of perchlorate to the matrix. As shown in the graph below the method of standard addition can be used to quantify low concentrations of analytes in complex matricies.

[image]

Table 1 is a comparison of 3 different methods for determining perchorate concentrations in fertilizer samples. As can be seen in Table 1 the accuracy of the ATR-FTIR method is comparable to both mass spectrometry and ion chromatography (IC) which are commonly used methods.

TABLE 1
Concentration of perchlorate in nitrate fertilizer samples.

| | concentration of perchlorate, weight % (±σ) | | |
|---|---|---|---|
| sample number | ATR-FTIR | mass spectrometry | ion chromatography |
| EPA #50 | 0.030 | 0.032 | 0.026 |
| EPA #55 | 0.012 | 0.023 | 0.020 |
| EPA #56 | 0.034 | 0.048 | 0.04 |

### Example 15

This example illustrates quantification of μM concentrations of ClO₄⁻.

In order to obtain concentration information using the probe coated with DEC⁺NO₃⁻, we plotted the rate of change of the absorbance at 1096 cm⁻¹ with time (see figure below) versus concentration. Although this graph is not linear this plot can be used as a calibration curve to determine an unknown concentration of ClO₄⁻ in the 0.03-10 μM concentration range (note that 0.03 μM ClO₄⁻ corresponds to 3 ppb ClO₄⁻).

[image]

### Example 16

This example illustrates detection of 5 μM C₈F₁₇SO₃⁻ in an aqueous solution.

A film of DEC⁺NO₃⁻ was deposited on the ATR crystal from a dichloromethane solution of the compound. After evaporation of dichloromethane, the probe was treated with 1 mL of an aqueous solution containing 5 μM C₈F₁₇SO₃⁻ (potassium salt). This concentration of the perfluorooctane sulfonate anion is equivalent to 2.5 ppm. As IR spectra were recorded over time, the intense band due to NO3⁻ at 1351 cm⁻¹ decreased in intensity while four bands due to the C₈F₁₇SO₃⁻ anion in the 1266-1150 cm⁻¹ region increased over time, as shown in the figure below. The four bands due to the C₈Fₗ₇SO₃⁻ anion were clearly visible after only 10 minutes. This example demonstrates that ppm concentrations of surfactant anions such as C₈F₇SO₃ can be detected within minutes by methods of the present invention.

[image]

### Example 17

This example illustrates detection of 0.05 μM of C₈F₁₇SO₃⁻ in an aqueous solution.

A film of DEC⁺NO₃⁻ was deposited on the ATR crystal from a dichloromethane solution of the compound. After evaporation of dichloromethane, the probe was treated with 100 mL of an aqueous solution containing 0.05 μM of C₈F₁₇SO₃⁻ (potassium salt). This concentration of the perfluorooctylsulfonate anion is equivalent to 25 ppb. As IR spectra were recorded over time, the intense band due to NO₃⁻ at 1351 cm⁻¹ decreased in intensity while four bands due to C₈F₁₇SO₃⁻ (PFOS) in the 1266-1150 cm⁻¹ region increased over time, as shown in the figure below. The four bands due to PFOS were clearly visible after only 30 minutes. This example demonstrates that ppb concentrations of surfactant anions such as PFOS can be detected within minutes by this method.

[image]

### Example 18

This example illustrates quantification of μM concentrations of PFOS.

In order to obtain concentration information using the probe coated with DEC⁺NO₃⁻, a plot of the rate of change of the absorbance at 1266 cm⁻¹ with time versus concentration was obtained (see figure below). The linear nature of this plot demonstrates that it can be used as a calibration curve to determine an unknown concentration of PFOS in the 0.05-10 μM concentration range (note that 0.05 μM PFOS corresponds to 25 ppb PFOS).

[image]

### Example 19

This example illustrates detection of 26 ppm aqueous CN⁻.

A film of Ni(DPPP)Cl₂ was deposited on the ATR crystal from a dichloromethane solution of the compound (DPPP=1,3-bis(diphenylphosphino)propane). After evaporation of solvent, the probe was treated with 1 mL of aqueous 1.00 mM KCN (this corresponds to 26 ppm CN⁻). The difference IR spectra shown below indicate that the treated probe can detect 26 ppm CN⁻ within 2-10 minutes (the spectrum that was subtracted was that of the Ni(DPPP)Cl₂ coating at the start of the experiment).

[image]

### Example 20

This example illustrates detection of 0.26 ppm aqueous CN⁻.

A film of Ni(DPPP)Cl₂ was deposited on the ATR crystal from a dichloromethane solution of the compound. After evaporation of solvent, the probe was treated with 100 mL of aqueous 0.01 mM KCN (this corresponds to 0.26 ppm CN⁻). The difference IR spectra shown below indicate that the treated probe can detect 0.26 ppm CN⁻ within 5-10 minutes (the spectrum that was subtracted was that of the Ni(DPPP)Cl₂ coating at the start of the experiment).

[image]

### Example 21

This example illustrates detection of 0.26 ppm aqueous CN⁻ in the presence of 1.0 M Cl⁻.

A film of Ni(DPPP)Cl₂ was deposited on the ATR crystal from a dichloromethane solution of the compound. After evaporation of solvent, the probe was treated with 100 mL of an aqueous solution that contained 0.01 mM KCN (this corresponds to 0.26 ppm CN⁻) and 1.0 M NaCl. The difference IR spectra shown below indicate that the treated probe can detect 0.26 ppm CN⁻ within 10 minutes even though the chloride ion co-contaminant is present in 100,000-fold excess (the spectrum that was subtracted was that of the Ni(DPPP)Cl₂ coating at the start of the experiment). It is believed that other co-contaminants such as sulfate, bromide, carbonate, and bicarbonate also do not interfere, and therefore it is possible that a probe coated with Ni(DPPP)Cl₂ or a similar analyte affinity compound can also detect cyanide in brackish water and seawater.

[image]

### Example 22

This example illustrates detection of 2.6 ppb aqueous CN₋.

A film of Ni(DPPP)Cl₂ was deposited on the ATR crystal by placing 20 μL of a dichloromethane solution containing 5 mM of the compound (DPPP =1,3-bis (diphenylphosphino)propane). After evaporation of solvent, the probe was treated with 1 L of aqueous 0.10 μM KCN (this corresponds to 2.6 ppb CN⁻). The pH of the solution was adjusted to 10 using NaOH to prevent evolution of HCN during the course of the experiment. The difference IR spectra shown below indicate that the treated probe can detect 2.6 ppb CN⁻ within 45 minutes (the spectrum that was subtracted was that of the Ni(DPPP)Cl₂ coating at the start of the experiment after 15 minutes of equilibration with distilled deionized water). The detection limit of the uncoated ASI SiComp® ATR-FTIR probe for aqueous CN⁻ was found to be about 26 ppm. Therefore, the coating of Ni(DPPP)Cl₂ has lowered the aqueous cyanide detection limit of the probe by a factor of at least about 10,000.

[image]

### Example 23

This example illustrates detection of 13 ppb aqueous CN⁻ in the presence of 0.5 M Cl⁻.

A film of Ni(DPPP)Cl₂ was deposited on the ATR crystal by placing 20 μL of a dichloromethane solution containing 5 mM of the compound (DPPP=1,3-bis (diphenylphosphino)propane). After evaporation of solvent, the probe was treated with 100 mL of an aqueous solution that contained 0.50 μM KCN (this corresponds to 13 ppb CN⁻) and 0.5 M NaCl. The reaction IR spectra shown below indicate that the treated probe can detect 13 ppb CN⁻ within 15 minutes even though the chloride ion co-contaminant is present in 10⁶-fold excess (the background used was that of the Ni(DPPP)Cl₂ coating after equilibrating with distilled deionized water for 10 minutes).

[image]

### Example 24

This example illustrates detection of 260 ppb aqueous CN₋ in the presence of a seawater simulant.

A film of Ni(DPPP)Cl₂ was deposited on the ATR crystal by placing 20 μL of a dichloromethane solution containing 5 mM of the compound (DPPP=1,3-bis (diphenylphosphino)propane). Seawater simulant contained such ions as chloride, sulfate, bromide, carbonate, and bicarbonate at concentrations similar to that found in seawater. After evaporation of solvent, the probe was treated with 100 mL of seawater simulant containing 10 μM KCN. The reaction IR spectra shown below indicate that the treated probe can detect 260ppb CN⁻ within 30 minutes (the background used was that of the Ni(DPPP)Cl₂ coating after equilibrating with distilled deionized water for 15 minutes).

[image]

### Example 25

This example illustrates quantification of μM concentrations of CN⁻.

In order to obtain concentration information using the probe coated with Ni(DPPP)Cl₂, the rate of change of the absorbance at 2104 cm⁻¹ with time versus concentration was plotted (see figure below). The linear nature of this plot demonstrates that it can be used as a calibration curve to determine an unknown concentration of CN⁻ in the 0.1-10 μM concentration range (note that 0.1 μM CN⁻ corresponds to 2.6 ppb CN⁻).

[image]

### Example 26

This example illustrates dectection of a protein at ppb concentration using DEC⁺Cl⁻.

Using a silicon ATR FTIR crystal coated with a DEC⁺Cl⁻ film, 10 ppb bovine serum albumin (BSA) was detected in less than 60 minutes. Detection was accomplished in an aqueous solution at pH=7, which is above the isoelectronic point for BSA. Detection of BSA was performed by monitoring the absorbance bands in the IR region from 950 -1400 cm-⁻¹ and spectra can be seen below. Peaks present in the spectra, correspond to peaks observed in spectra of pure BSA in water. The detection limit of BSA in water using an unmodified probe is believed to be approximately 2000 ppm.

[image]

Detection experiments were also performed with neutral DEC films in order to elucidate the mechanism of extraction. The neutral film showed no response to 1 ppm BSA in 1 hour. The only responses observed were negative peaks due to the loss of the DEC film and the subsequent increase in water bands. This experiment suggests that the extraction (i.e., affinity) mechanism is ion-exchange and not merely incorporation of the protein into the organometallic film.

### Example 27

This example illustrates detection of penicillin-G in aqueous solution using DEC⁺HSO₄⁻.

Using a silicon ATR FTIR crystal coated with a DEC⁺HSO₄⁻ film, 10 mM penicillin-G was detected. Detection was accomplished in an aqueous solution at pH=7. Detection of penicillin-G was performed by monitoring the IR absorbance band at 1640 cm⁻¹. As can be seen in the graph below the top and middle spectra show pencillin-G after extraction with DEC⁺HSO₄⁻, the top spectrum is in the presence of water while the middle spectrum shows the film after it has been dried (i.e., after the water has been removed). The bottom spectrum is of the potassium salt of penicillin-G as a solid.

[image]

### Example 28

This example illustrates lower detection limits are possible using extractant films.

The table below is a compilation of some of the anions detected and the sensitivity increase afforded by using extractant films (i.e., analyte affinity compound) coating the ATR sensor. Other suitable anions include, but are not limited to, ClO₃⁻, C₄F₉SO₃⁻, C₆H₁₃OSO₃⁻, OCN₋, NO₂⁻, N ₃⁻, PF₆⁻, as well fluorinated surfactants contained in aqueous film forming foams formulations (AFFF).

Table of Sensitivity increases using an extractant film
(i.e., analyte affinity compound).

| | detection limit | | sensitivity | time |
|---|---|---|---|---|
| anions | no film (mM) | film (μM) | increase | (min) |
| CN⁻ | 1 | 0.1 | 10,000 | 45 |
| ClO₄⁻ | 2.3 | 0.03 | 76,000 | 30 |
| PFOS | 0.2 | 0.05 | 4,000 | 30 |
| CF₃SO₃⁻ | 3.2 | 0.1 | 32,000 | 20 |
| SCN⁻ | 2 | 0.3 | 6,700 | 30 |
| NO₃⁻ | 4 | 0.4 | 10,000 | 20 |
| ReO₄⁻ | 50 | 16.1 | 3,100 | 13 |
| DDS | 0.5 | 1.2 | 420 | 20 |
| penicillin-G | 3.5 | 260 | 14 | 1 |

### Example 29

The ATR crystal can also be coated with a composite material of an analyte affinity compound chemically bonded or physically trapped in a layer of nanoporous SiO₂ or another metal oxide prepared using sol-gel techniques. The sol-gel coating containing an analyte affinity compound can vary in thickness from a fraction of a micron to several microns, depending on the application.

### Example 30

The coating for the ATR crystal can also be a composite material of an analyte affinity compound chemically bonded or physically trapped in a layer of an organic or inorganic polymer. This polymer coating comprising an analyte affinity compound can vary in thickness from a fraction of a micron to several microns, depending on the application. The polymers used can be simple “carriers” for the analyte affinity compound or they can be designed to enhance the sensitivity of the coating for particular analytes.

### Example 31

The analyte affinity compound coating for the ATR crystal can be composed of a cation affinity compound instead of an anion affinity compound. Two-cation affinity compound that can be used include Na[Fe(η⁵-C₅H₅)(η⁵-(3)-1,2-C₂B₉H₉(n-C₁₂H₂₅)₂)](Na⁺I⁻) and Na[Fe(η⁵-C₅H₅)(η⁵-(3)-1,2-C₂B₉H₇(n-C₁₂H₂₅)₂-9,12Br₂)], which are described by Clark, J. F.; Chamberlin, R. M.; Abney, K. D.; and Strauss, S. H. in “Design and Use of a Redox-Recyclable Organometallic Extractant for the Cationic Radionuclides ¹³⁷Cs⁺ and ⁹⁰Sr²⁺,” Environ. Sci. Technol. 1999, 33, 2489-2491, which is incorporated herein by reference in its entirety.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A detection probe for an analytical device comprising:
(a) a detection zone for transmitting a signal to the analytical device;
(b) an analyte affinity compound attached to said detection zone, wherein said analyte affinity compound is capable of being activated and deactivated without a significant loss of performance, and when said analyte affinity compound is activated it is capable of increasing the relative concentration of the analyte on said detection zone compare to the concentration of the analyte in the fluid medium when said detection zone is contacted with the fluid medium comprising the analyte.

2. The detection probe of claim 1, wherein the analytical device is an IR spectrometer.

3. The detection probe of claim 2, wherein the analytical device is an attenuated total reflection IR spectrometer.

4. The detection probe of claim 1, wherein said detection probe is an electrochemical sensor probe.

5. The detection probe of claim 1, wherein said analyte affinity compound is a redox-recyclable compound.

6. The detection probe of claim 5, wherein said analyte affinity compound is covalently bonded to said detection zone.

7. The detection probe of claim 6, wherein said analyte affinity compound further comprises a linker that covalently bonds said detection probe to said analyte affinity compound.

8. The detection probe of claim 5, wherein said analyte affinity compound comprises a lipophilic portion.

9. The detection probe of claim 5, wherein said analyte affinity compound is ionizable in the fluid medium.

10. The detection probe of claim 9, wherein at least a portion of counter ion of said analyte affinity compound is exchanged with said analyte in the fluid medium when said detection probe is contacted with the fluid medium, thereby providing a relatively higher concentration of the analyte proximal to the detection zone compared to the concentration of the analyte in the fluid medium.

11. The detection probe of claim 5, wherein said analyte affinity compound is an organometallic compound.

12. The detection probe of claim 11, wherein said analyte affinity compound is selected from the group consisting of 1,1′,3,3′-tetrakis(2-methyl-2-hexyl) ferricenium nitrate, 1,1′,3,3′-tetrakis(2-methyl-2-hexyl)ferricenium chloride, 1,1′,3,3 ′-tetrakis(2-methyl-2-nonyl)ferricenium nitrate, 1,1′,3,3′-tetrakis(2-methyl-2-nonyl)ferricenium chloride,Ni(DPPP)Cl₂ and the Eu/styrene MIP.

13. A method for providing a higher concentration of an analyte proximal to a detection zone of a detection probe of an analytical device relative to the concentration of the analyte in a fluid medium in contact with the detection probe, said method comprising attaching a redox-recyclable analyte affinity compound to the detection zone, wherein when said analyte affinity compound is activated it has a higher affinity for the analyte compare to the fluid medium, thereby increasing the analyte concentration proximal to the detection zone relative to the analyte concentration in the fluid medium when said detection zone is contacted with the fluid medium comprising the analyte.

14. The method of claim 13 further comprising activating the analyte affinity compound prior to contacting the detection zone to the fluid medium.

15. The method of claim 14, wherein said activation step comprises oxidizing the analyte affinity compound.

16. The method of claim 15, wherein said oxidizing step comprises electrochemical oxidation, chemical oxidation, or mixtures thereof.

17. The method of claim 13, wherein the detection probe is an attenuated total reflection infrared spectroscopy probe.

18. The method of claim 13, wherein the detection probe is an electrochemical sensor probe.

19. The method of claim 13, wherein the analyte is selected from the group consisting of a perfluoroalkylsulfonate ion, an alkylsulfate ion, a carborane monoanion, tetrafluoroborate, hexafluorophosphate, perchlorate, pertechnetate, perrhenate, cyanide, cyanate, thiocyanate, a monoalkyl ester of deprotonated alkylphosphonic acid, bisulfate, a peptide, an antibiotic, perfluorocarboxylate, nitrite, chlorate, and azide.

20. The method of claim 13, wherein the analyte affinity compound is selected from the group consisting of 1,1′,3,3′-tetrakis(2-methyl-2-hexyl)ferricenium nitrate, 1,1′,3,3′-tetrakis(2-methyl-2-hexyl)ferricenium chloride, 1,1′,3,3′-tetrakis(2-methyl-2-nonyl)ferricenium nitrate, 1,1′,3,3′-tetrakis(2-methyl-2-nonyl)ferricenium chloride, Ni(DPPP)Cl₂ and the Eu/styrene MIP.

21. A method for lowering a detection limit of an analytical device for measuring an analyte in a fluid medium, wherein the analytical device comprises a detection zone, said method comprising attaching an analyte affinity compound capable of being activated and deactivated without a significant loss of performance to the detection zone such that when the detection zone having an activated analyte affinity compound is contacted with a fluid medium, the analyte affinity compound provides a higher analyte concentration proximal to the detection zone relative to the analyte concentration in the fluid medium, thereby increasing the effective concentration of the analyte proximal to the detection zone thus effectively lowering the analyte concentration detection limit of the analytical device.

22. The method of claim 21, wherein the analyte is selected from the group consisting of a perfluoroalkylsulfonate ion, an alkylsulfate ion, a carborane monoanion, tetrafluoroborate, hexafluorophosphate, perchlorate, pertechnetate, perrhenate, cyanide, cyanate, thiocyanate, a monoalkyl ester of deprotonated alkylphosphonic acid, bisulfate, a peptide, an antibiotic, perfluorocarboxylate, nitrite, chlorate, and azide.

23. The method of claim 21, wherein the analyte affinity compound is a redox-recyclable compound.

24. The method of claim 23, wherein the analyte affinity compound is selected from the group consisting of 1,1′,3,3′-tetrakis(2-methyl-2-hexyl)ferricenium nitrate, 1,1′,3,3′-tetrakis(2-methyl-2-hexyl)ferricenium chloride, 1,1′,3,3′-tetrakis(2-methyl-2-nonyl)ferricenium nitrate, 1,1′,3,3′-tetrakis(2-methyl-2-nonyl)ferricenium chloride, Ni(DPPP)Cl₂ and the Eu/styrene MIP.

25. A method for increasing the concentration of an analyte on a detection probe, which is in communication with an analytical device, relative to the concentration of the analyte in a fluid medium, said method comprising:
(a) attaching an analyte affinity compound having a higher affinity for the analyte than the fluid medium on to a surface of the detection probe; and
(b) contacting the detection probe with the fluid medium comprising the analyte.

26. The method of claim 25, wherein the analytical device is an IR spectrometer.

27. The method for claim 25, wherein the analyte is selected from the group consisting of a perfluoroalkylsulfonate ion, an alkylsulfate ion, a carborane monoanion, tetrafluoroborate, hexafluorophosphate, perchlorate, pertechnetate, perrhenate, cyanide, cyanate, thiocyanate, a monoalkyl ester of deprotonated alkylphosphonic acid, bisulfate, a peptide, an antibiotic, perfluorocarboxylate, nitrite, chlorate, and azide.

28. The method of claim 25, wherein the analyte affinity compound is a redox-recyclable compound.

29. The method of claim 25, wherein the analyte affinity compound is selected from the group consisting of 1,1′,3,3′-tetrakis(2-methyl-2-hexyl)ferricenium nitrate, 1,1′,3,3′-tetrakis(2-methyl-2-hexyl)ferricenium chloride, 1,1′,3,3′-tetrakis(2-methyl-2-nonyl)ferricenium nitrate, 1,1′,3,3′-tetrakis(2-methyl-2-nonyl)ferricenium chloride, Ni(DPPP)Cl₂ and the Eu/styrene MIP.

30. A method for detecting an analyte in a solution using an attenuated total reflectance Fourier-transform infrared spectroscopy, said method comprising:
(a) contacting the solution with an ATR-IR detection probe, wherein the ATR-IR detection probe comprises an analyte affinity compound that has a higher affinity for the analyte than the solution;
(b) obtaining an infrared spectroscopy of the solution; and
(c) determining the presence of the analyte.
